(19) United States
(12) Patent Application Publication
(10) Pub. No.: US 2015/0019298 A1
(43) Pub. Date: Jan. 15, 2015

(54) ESTIMATING PATH INFORMATION IN BUSINESS PROCESS INSTANCES WHEN PATH INFORMATION INFLUENCES DECISION

(71) Applicant: INTERNATIONAL BUSINESS MACHINES CORPORATION, Armonk, NY (US)

(72) Inventors: Francisco Curbera, Yorktown Heights, NY (US); Yurdaer N. Doganata, Chestnut Ridge, NY (US); Geetika T. Lakshmanan, Winchester, MA (US); Merve Unuvar, New York, NY (US)

(21) Appl. No.: 13/939,362

(22) Filed: Jul. 11, 2013

(51) Int. Cl. G06Q 10/06

(52) U.S. Cl. CPC G06Q 10/06375
USPC 705/7.37

(57) ABSTRACT

Systems and methods for predicting trace information include determining a plurality of trace candidates for one or more traces having missing path information, the plurality of trace candidates having path information for tasks of a business process model, which includes a plurality of independent parallel paths. Probabilities that each of the plurality of trace candidates for the business process model is an actual trace are computed using a processor for the one or more traces. One of the plurality of trace candidates is identified as the actual trace based on the probabilities to predict path information of the one or more traces.

### BACKGROUND

1. Technical Field

The present invention relates to business process management, and more particularly to estimating path information in business process instances when path information influences decision.

2. Description of the Related Art

In most business processes, the path of tasks visited in a process prior to a decision influences that decision. For example, in the insurance industry, the path of opening a claim, getting an accident report and confirming the accident with witnesses may be more likely to lead to a result of paying for damages to a car over a path of opening a claim, auditing policies and confirming the invalidity of the policies. Different paths in a process may bias different decisions. A path refers to the sequence of executed tasks and their order of execution. For such processes, including path information into predictions is important in making better predictions.

Including this path information into predictions for processes where there are no parallel paths is straightforward. The task execution sequence, i.e., the execution trace, of a process without any parallel paths captures the process behavior uniquely since tasks are executed sequentially one after another. However, this is not the case for processes with multiple independent parallel paths, where multiple tasks may be executed simultaneously. In such cases, task execution order may correspond to multiple instances since task executions are not sequential. Thus, in a process that includes multiple parallel independent paths, task execution order does not necessarily contain the path information without which predicting the output of a process may not be possible.

### SUMMARY

A method for predicting trace information includes determining a plurality of trace candidates for one or more traces having missing path information, the plurality of trace candidates having path information for tasks of a business process model, which includes a plurality of independent parallel paths. Probabilities that each of the plurality of trace candidates for the business process model is an actual trace are computed using a processor for the one or more traces. One of the plurality of trace candidates is identified as the actual trace based on the probabilities to predict path information of the one or more traces.

A system for predicting trace information includes an identification module configured to determine a plurality of trace candidates for one or more traces having missing path information, the plurality of trace candidates having path information for tasks of a business process model, which includes a plurality of independent parallel paths. A statistical analysis module is configured to compute, using a processor, probabilities that each of the plurality of trace candidates for the business process model is an actual trace for the one or more traces. An estimation module is configured to identify one of the plurality of trace candidates as the actual trace based on the probabilities to predict path information of the one or more traces.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system for trace prediction, in accordance with one illustrative embodiment;

FIG. 2 shows an exemplary business process model, in accordance with one illustrative embodiment;

FIG. 3 shows an overview of possible paths of a business process model, in accordance with one illustrative embodiment; and

FIG. 4 is a block/flow diagram showing a method for trace prediction, in accordance with one illustrative embodiment.

### DETAILED DESCRIPTION OF PREFERRED EMBODIMENTS

In accordance with the present principles, systems and methods of estimating path information in business process instances are provided. Often times, the task execution sequence (i.e., execution trace or trace) of a process may influence a final decision or outcome. However, in a process having multiple parallel independent paths where multiple tasks may be executed simultaneously, the trace may not include the path information. The present principles predict or estimate the order of simultaneous executions in business processes where there are multiple parallel independent paths.

For a given trace of a business process model, trace candidates having path information are identified. The path probability distribution is then computed for each trace candidate. Computing the path probability distribution may first include identifying sub-traces of each trace candidate. Sub-traces refer to traces of a trace candidate associated with one of the parallel paths in the business process model. For each incomplete sub-trace, the number of tasks performed is determined. An incomplete sub-trace is a sub-trace that does not reach a final decision node. The execution time of the trace and tasks of the trace are measured, and the mean and standard deviation of completion times for a set of all traces is determined to compute the probability of executing the number of tasks for each incomplete trace within the execution time. The time to complete each task is assumed to have a normal distribution. For each trace candidate, the probabilities for its incomplete sub-traces are multiplied together to determine the probability that that trace candidate is the actual trace.

Based on the probabilities, a trace candidate is selected. Preferably, a random number generator is employed and configured to account for the probabilities. Historic traces may be employed by the present principles to train a classifier and form a predictive model. Using the predictive model, the outcomes of traces enhanced with the present principles may be determined.

The present principles enhance traces with addition path information, which reduces uncertainty. For prediction problems where path influences the decision, accurately predicting path attributes generally yields better outcome predictions. Moreover, for path compliance, if one knows the path accurately, they can take appropriate actions. Knowing the path information can derive insights about the business process model.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

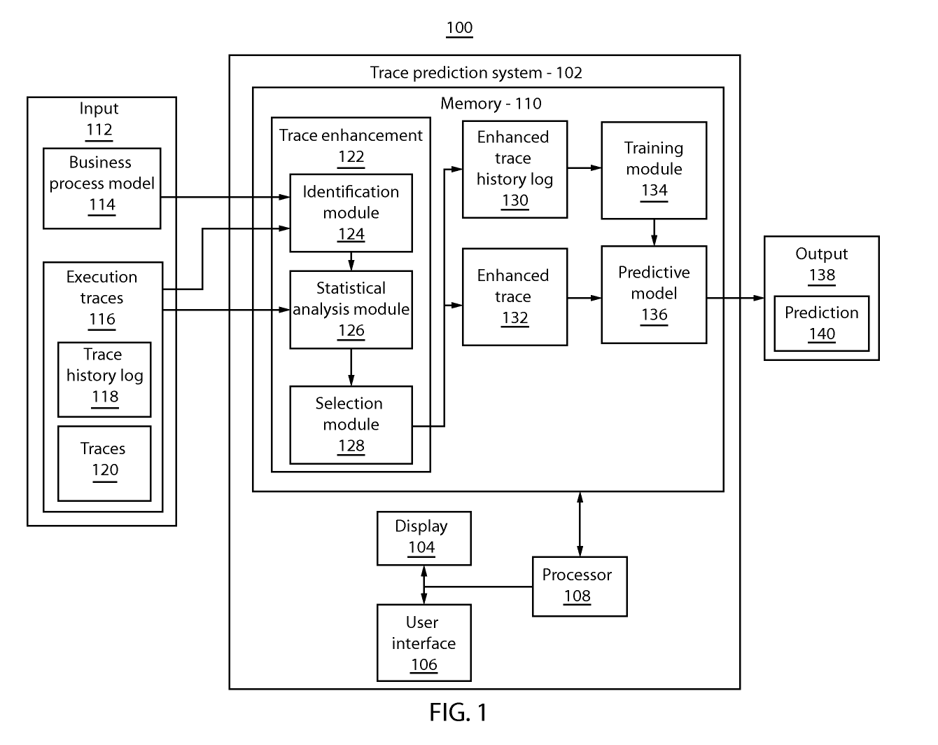

Referring now to the drawings in which like numerals represent the same or similar elements and initially to FIG. 1, a block/flow diagram showing a high-level overview of a system for trace prediction 100 is illustratively depicted in accordance with one embodiment. The system 100 enhances path sequences in multiple independent trace executions to better predict decisions.

While the present principles are described in terms of healthcare, it should be understood that the present principles are not so limited. Rather, other applications are also contemplated within the scope of the present principles, such as, e.g., insurance.

The system 100 may include a system or workstation 102. The system 102 preferably includes one or more processors 108 and memory 110 for storing applications, modules and other data. The system 102 may also include one or more displays 104 for viewing. The displays 104 may permit a user to interact with the system 102 and its components and functions. This may be further facilitated by a user interface 106, which may include a mouse, joystick, or any other peripheral or control to permit user interaction with the system 102 and/or its devices. It should be understood that the components and functions of the system 102 may be integrated into one or more systems or workstations, or may be part of a larger system or workstation.

The system 102 may receive input 112, which may include a business process model 114 and execution traces 116 of the business process model 114. A trace of a business process model includes the tasks executed during the course of that business process model, and data and metadata associated with each task. Metadata associated with a task could include the timestamp at which the task began executing. Data associated with a task could be value such as Amount in Dollars (numeric type).

Execution traces 116 preferably have missing path information. Execution traces 116 may be from the trace history log 118 and/or traces 120. The trace history log 118 includes outcomes associated with each trace and is used to train a classifier and build a predictive model. An outcome refers to a result of a decision. Traces 120 are traces where the outcomes are to be predicted. In one embodiment, traces 120 may include test traces used to evaluate the accuracy of the predictive model by comparing the predicted outcome with the known outcome. Traces 120 use the predictive model to predict outcomes based on estimated path information. This will be explained in more detail below.

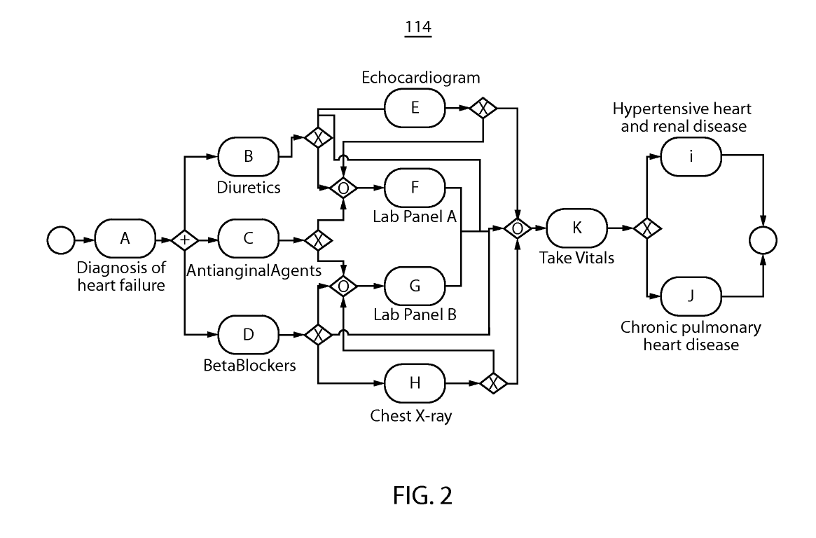

Referring for a moment to FIG. 2, with continued reference to FIG. 1, an exemplary business process model 114 is illustratively depicted in accordance with one embodiment. Each node of the business process model 114 is associated with an event, such as, e.g., a medical event. Medical events may include, e.g., medications, labs, diagnoses, vital signs, etc. The business process model 114 preferably includes multiple parallel independent paths. The prediction of the outcome of decision at node K is influenced by which path is taken.

Referring back to FIG. 1, trace enhancement module 122 is configured to receive the business process model 114 and execution traces 116 and enhance the execution traces 116 by predicting path information. A path is the sequence of executed tasks and their order of execution. Trace enhancement module 122 includes an identification module 124 configured to receive the business process model 114 and the execution traces 116 to identify possible parallel independent paths for a given execution trace 116. Independent paths here mean that the tasks that are being executed in one parallel path do not influence the executions/decisions of the tasks that are being executed in any other parallel path.

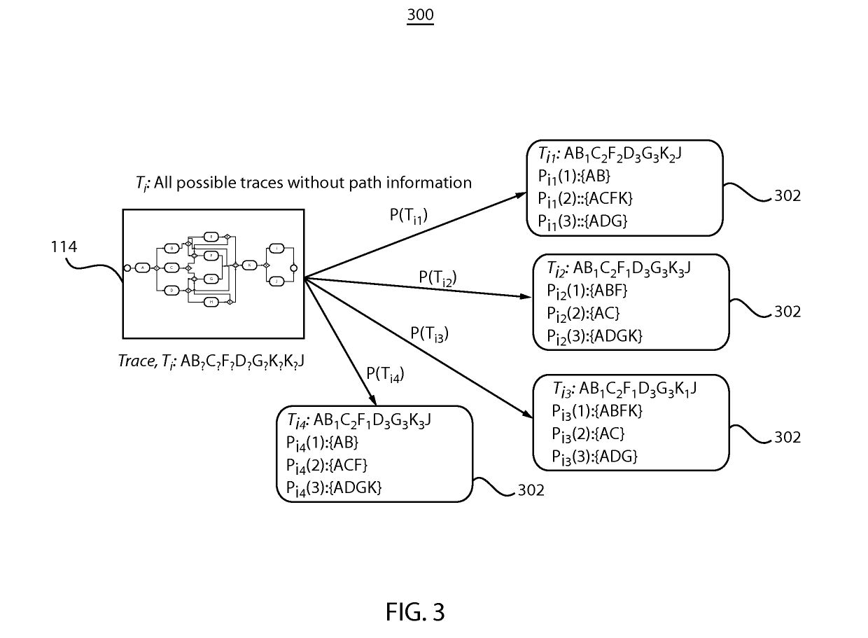

Referring for a moment to FIG. 3, with continued reference to FIGS. 1 and 2, an overview 300 of possible paths of a business process model 114 for an execution trace 116 is illustratively depicted in accordance with one embodiment. In the business process model 114 of FIG. 2, labels for the execution trace 116 of ABCFDGKJ are found. Identification module 124 is configured to identify all possible execution instances 302 of the execution trace 116: AB1C2F2D3G3K2J, AB1C2F1D3G3K3J, AB1C2F1D3G3K1J, and AB1C2F1D3G3K3J. Integer values after each node denote the path on which the node is executed.

For example, consider the first possible execution trace AB1C2F2D3G3K2J. Node B was first executed over the first parallel path, then node C was executed on the second parallel path after node B. This ordering indicates that node C is finished before node D is started on the third parallel path, since C2 is followed by F2, and F2 is followed by D3. While the first parallel path was still executing node B, the third parallel path (starting with node D) finished and started executing node G, and the second parallel path (starting with node C) arrived at node K. Since the second parallel path arrived to node K before the first and third parallel paths, the second parallel path makes the final decision on node J. The first and third parallel paths are referred to as incomplete traces since they are not the ones that yield to the final outcome. Parallel paths for each possible execution instance 302 are shown in FIG. 3.

Referring back to FIG. 1, after identifying all possible paths in the identification module 124, statistical analysis module 126 computes probability distributions for each possible path. For a given trace Tᵢ (received as an input as execution trace 116), take the list of all possible traces from identification module 124. Let trace Tᵢⱼ be the j-th possible realization of trace Tᵢ. For every trace Tᵢⱼ, associated parallel paths are determined. Let Pᵢⱼ(k) denote the k-th parallel path associated with the trace Tᵢⱼ, where k=1, . . . , m and m is the number of parallel paths in the given business process model 114. The parallel paths Pᵢⱼ(k) that do not reach the final decision node are referred to as incomplete paths, and the parallel path that does is referred to as the complete path. All parallel paths Pᵢⱼ(k) are identified for each Tᵢⱼ, including complete and incomplete paths. Let Nᵢⱼ(k) represent the total number of tasks in parallel path Pᵢⱼ(k). For each incomplete parallel path Pᵢⱼ(k), the number of tasks (or nodes) is determined. This may include determining which tasks were executed, their timestamps for when they started to execute, and their order of execution.

Statistical analysis module 126 also receives execution traces 116. Independently, the time Yᵢ to complete end-to-end execution of trace Tᵢ is measured. Yᵢ is the sum of the execution times of individual tasks in Tᵢ. Let tᵣᵢ denote the time to complete task r in Trace Tᵢ (assuming task r exists in Tᵢ, otherwise tᵣᵢ is 0). The mean, μᵣ, and standard deviation, σᵣ, of task r is computed using the values obtained for tᵣᵢ from execution traces 116.

For every incomplete path Pᵢⱼ(k), the probability Pr(Nᵢⱼ(k)) of executing Nᵢⱼ(k) tasks in Yᵢ time is computed. A general expression for such probability can be provided by assuming the execution time of task r is a normally distributed random variable with mean, μ, and standard deviation, σ, (for every task) as follows in equation (1). Other known probability distributions may also be employed.

Pr(Nᵢⱼ(k))=½(1+erf((Yᵢ−Nᵢⱼ(k)μ)/(\sqrt{2Nᵢⱼ(k)σ²}))) (1)

By assuming that the execution of each parallel path is independent of each other, the probability of Tᵢ being Tᵢⱼ is computed in equation (2) by simply multiply the probabilities of executing incomplete paths Pr(Nᵢⱼ(k)) in Yi time, where C is the normalizing factor. Note that there are total of (m−1) incomplete traces, since one of the parallel paths Pᵢⱼ(k) is the complete trace. The probability of realizing Tᵢⱼ is computed by considering the probability of executing Nᵢⱼ(k) tasks on each incomplete path k when the process completes.

Pr(Tᵢⱼ)={Pr(Nᵢⱼ(1))·Pr(Nᵢⱼ(2)) . . . Pr(Nᵢⱼ(m−1))}·C (2)

To illustrate the steps of statistical analysis module 126, consider the input trace Tᵢ: ABCFDGKKJ. Four different possible realizations for trace Tᵢ are found, as shown in FIG. 3 as Tᵢ₁, Tᵢ₂, Tᵢ₃, and Tᵢ₄. The calculation of the probability of Tᵢ₁ will be shown below, however the remaining realizations follow similar steps.

The parallel paths for Tᵢ₁ are obtained from the business process model 114 (in FIG. 2) as: Pᵢ₁(1): AB; Pᵢ₁(2): ACFG; and Pᵢ₁(3): ADG. Note that Pᵢ₁(2) is the complete path since it is the only path to reach the final decision node K. The rest are incomplete paths since they have not reached the decision node K. The number of tasks for each incomplete path, Nᵢ₁(1) and Nᵢ₁(3), for Pᵢ₁(1) and Pᵢ₁(3), are calculated as Nᵢ₁(1)=2 and Nᵢ₁(3)=3.

The time Yᵢ to complete the whole trace ABCFDGKKJ is then measured. Then, the mean and standard deviation of the completion time is measured for each task r, from all execution traces. For instance, the execution times t_{iA} for each trace are gathered and the mean and standard deviation of t_{iA} are estimated. For the sake of simplicity, without loss of generality, it is assumed that each task execution time has the same distribution with mean μ and standard deviation σ.

The probability of executing Nᵢⱼ(k) tasks within Yᵢ is calculated for each Pᵢⱼ(k). For instance, for Pr(Nᵢ₁(1)), the probability of executing 2 tasks within Yᵢ for Pᵢ₁(1) is calculated by assuming that the time to complete tasks A and B have Normal distributions with same mean and standard deviation as follows:

Pr(Nᵢ₁(1))=Pr(2)=½(1+erf((Yᵢ−2μ)/(\sqrt{4σ²}))). (3)

Similarly, the probability of executing 3 tasks within Yᵢ for Pᵢ₁(3) is calculated as follows:

Pr(Nᵢ₁(3))=Pr(3)=½(1+erf((Yᵢ−3μ)/(\sqrt{6σ²}))). (4)

By using these probabilities and assuming independence, the probability that Tᵢ₁ is the execution trace is calculated as follows:

Pr(Tᵢ₁)={Pr(2)·Pr(3)}·C (5)

Similar steps are also performed for Tᵢ₂, Tᵢ₃, and Tᵢ₄. Results are summarized below.
Tᵢ₁: AB1C2F2D3G3K2J
   Pᵢ₂: AB Nᵢ₁(1)=2, Pr(2)
   Pᵢ₂: ACFK
   Pᵢ₂: ADG Nᵢ₁(3)=3, Pr(3)
   Pr(Tᵢ₁)={Pr(2) Pr(3)} C
Tᵢ₂: AB1C2F1D3D3G3K3J
   Pᵢ₂: ABG Nᵢ₂(1)=2, Pr(2)
   Pᵢ₂: AC Nᵢ₂(2)=3, Pr(3)
   Pᵢ₂: ADGK
   Pr(Tᵢ₂)={Pr(2) Pr(3)} C
Tᵢ₃: AB1C2F1D3G3K1J
   Pᵢ₂: ABFK
   Pᵢ₂: AC Nᵢ₂(2)=2, Pr(2)
   Pᵢ₂: ADG Nᵢ₂(3)=3, Pr(3)
   Pr(Tᵢ₃)={Pr(2) Pr(3)} C
Tᵢ₄: AB1C2F1D3G3K3J
   Pᵢ₂: AB Nᵢ₄(1)=2, Pr(2)
   Pᵢ₂: ACF Nᵢ₄(2)=3, Pr(3)
   Pᵢ₂: ADGK
   Pr(Tᵢ₄)={Pr(2) Pr(3)} C

Selection module 128 is configured to select one of the possible paths based on the computed probabilities of statistical analysis module 126. The probabilities Pr(Tᵢⱼ) for each possible realization are received from statistical analysis module 126. A random number is generated to decide which realization to select using, e.g., a random number generator. Numbers of the set of numbers used by the random number generator are associated with each realization, in accordance with the probabilities Pr(Tᵢⱼ). For instance, in the above example, Pr(Tᵢ₁)=Pr(Tᵢ₂)=Pr(Tᵢ₂)=Pr(Tᵢ₂)=0.25. The set of numbers used by the random number generator will be equally associated with each realization. Other configurations to select traces may also be employed.

Trace enhancement module 122 enhances trace history log 118 and/or traces 120 by predicting path information and stores them as enhanced trace history log 130 and enhanced traces 132 in memory 110. Enhanced trace history log 130 is used by training module 134 to train a classification algorithm (shortly referred as classifier above) and determine a predictive model 136. The classification algorithm may include, e.g., a linear classifiers, decision trees, neural networks etc. The predictive model 136 may then be used to predict decisions of traces 120 by first enhancing them. The predictive model 136 is run against the enhanced traces 132 to provide a prediction 140 of an outcome. The prediction 140 may be an output 138 of the system 102.

In one embodiment, the traces 120 include test traces, which are enhanced by trace enhancement module 122 and applied to the predictive model 136. The prediction 140 of the test traces 120 is compared against the known outcome of test traces 120 to evaluate the accuracy (i.e., strength) of the predictive model 136. However, it should be understood that traces 120 may include any trace where the outcome is to be predicted.

One advantage of the present invention is that by introducing additional path information, uncertainty is reduced. For prediction, if a path attribute is the most significant one, predicting that attribute accurately will generally yield better results. Moreover, if one knows the path accurately, they can take appropriate actions.

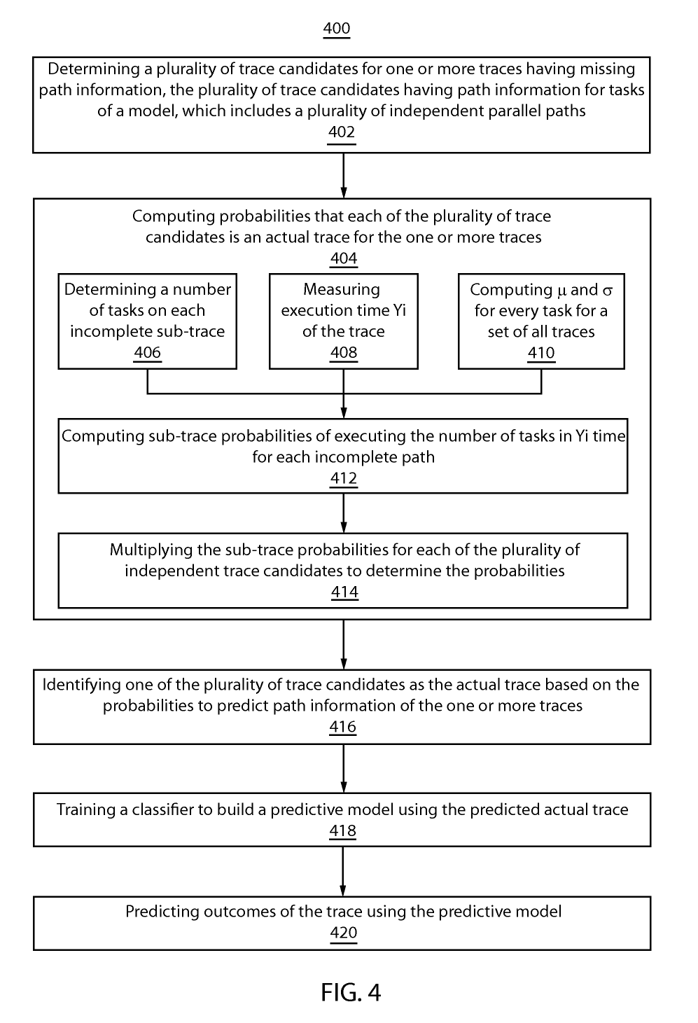

Referring now to FIG. 4, a block/flow diagram is shown for a method for estimating path information 400 in accordance with one illustrative embodiment. In block 402, a plurality of independent trace candidates is identified for one or more traces having missing path information. The one or more traces are preferably traces of tasks in a business process model. A business process model may include a plurality of independent paths the trace may include. The missing path information preferably includes missing information indicating paths associated with tasks. The trace may include a trace from a trace history log or a trace where an outcome is to be predicted. In one embodiment, the plurality of independent candidate traces includes all possible candidate traces.

In block 404, probabilities that each of the plurality of trace candidates is an actual trace for the one or more traces are computed. For each of the plurality of trace candidates, sub-traces are identified. Sub-traces refer to traces of the trace candidate that are associated with one of the independent paths of the business process model. Incomplete sub-traces are identified for each of the plurality of independent trace candidates. An incomplete sub-trace is a sub-trace associated with an independent path that does not reach a final decision node. In block 406, a number of tasks for each incomplete sub-trace are determined.

In block 408, execution times Yᵢ of the one or more traces are measured. The execution time Yᵢ may be the sum of the execution times of individual tasks for each of the one or more traces. In block 410, the mean μ and standard deviation r of completion time are computed for every task for a set of all traces. Computing the mean and standard deviation may include determining the time tᵣᵢ to complete task r in trace Tᵢ for the set of all trace.

In block 412, sub-trace probabilities of executing the number of tasks in Tᵢ time is computed for each incomplete sub-trace. In block 414, for each of the plurality of trace candidates, the sub-trace probabilities of executing the number of tasks in Tᵢ time are multiplied together for the incomplete sub-traces to compute the probabilities that each of the plurality of trace candidates is the actual trace.

In block 416, one of the plurality of trace candidates is identified as the actual trace based on the probabilities to predict path information of the one or more traces. A random number generator may be employed to randomly select a number in accordance with the probabilities.

In block 418, a classifier is trained to build a predictive model using the predicted actual trace. Traces from a trace history log include outcomes and may be used to train the classifier. In block 420, outcomes of the trace are predicted using the predictive model. Where the traces are test traces, the predicted outcome may be compared with a known outcome to evaluate the strength of the predictive model.

Having described preferred embodiments of a system and method for estimating path information in business process instances when path information influences decision (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for predicting trace information, comprising:
determining a plurality of trace candidates for one or more traces having missing path information, the plurality of trace candidates having path information for tasks of a business process model, which includes a plurality of independent parallel paths;
computing, using a processor, probabilities that each of the plurality of trace candidates for the business process model is an actual trace for the one or more traces; and
identifying one of the plurality of trace candidates as the actual trace based on the probabilities to predict path information of the one or more traces.

2. The method as recited in claim 1, wherein computing includes:
identifying sub-traces for each of the plurality of trace candidates, the sub-traces being traces that are associated with one of the plurality of independent parallel paths; and
determining a number of tasks on each incomplete sub-trace.

3. The method as recited in claim 2, wherein computing includes measuring an execution time of the one or more traces and tasks in the one or more traces.

4. The method as recited in claim 3, wherein computing includes calculating a mean and standard deviation of execution times for each task of the one or more traces.

5. The method as recited in claim 4, wherein computing includes calculating sub-trace probabilities of executing the number of tasks in the execution time for each incomplete sub-trace.

6. The method as recited in claim 5, wherein computing includes multiplying together the sub-trace probabilities of one of the one or more trace candidates to compute the probabilities.

7. The method as recited in claim 1, wherein identifying includes randomly identifying one of the plurality of trace candidates in accordance with the probabilities.

8. The method as recited in claim 7, wherein randomly identifying includes randomly generating a random number in accordance with the probabilities.

9. The method as recited in claim 1, further comprising training a classifier to build a predictive model using the actual trace.

10. The method as recited in claim 9, further comprising predicting outcomes of the one or more traces using the predictive model.

11. A computer readable storage medium comprising a computer readable program for predicting trace information, wherein the computer readable program when executed on a computer causes the computer to perform the steps of:
determining a plurality of trace candidates for one or more traces having missing path information, the plurality of trace candidates having path information for tasks of a business process model, which includes a plurality of independent parallel paths;
computing probabilities that each of the plurality of trace candidates for the business process model is an actual trace for the one or more traces; and
identifying one of the plurality of trace candidates as the actual trace based on the probabilities to predict path information of the one or more traces.

12. A system for predicting trace information, comprising:
an identification module configured to determine a plurality of trace candidates for one or more traces having missing path information, the plurality of trace candidates having path information for tasks of a business process model, which includes a plurality of independent parallel paths;
a statistical analysis module configured to compute, using a processor, probabilities that each of the plurality of trace candidates for the business process model is an actual trace for the one or more traces; and
an estimation module configured to identify one of the plurality of trace candidates as the actual trace based on the probabilities to predict path information of the one or more traces.

13. The system as recited in claim 12, wherein computing includes:
identifying sub-traces for each of the plurality of trace candidates, the sub-traces being traces that are associated with one of the plurality of independent parallel paths; and
determining a number of tasks on each incomplete sub-trace.

14. The system as recited in claim 13, wherein computing includes measuring an execution time of the one or more traces and tasks in the one or more traces.

15. The system as recited in claim 14, wherein computing includes calculating a mean and standard deviation of execution times for each task of the one or more traces.

16. The system as recited in claim 15, wherein computing includes calculating sub-trace probabilities of executing the number of tasks in the execution time for each incomplete sub-trace.

17. The system as recited in claim 16, wherein computing includes multiplying together the sub-trace probabilities of one of the one or more trace candidates to compute the probabilities.

18. The system as recited in claim 12, wherein identifying includes identifying one of the plurality of trace candidates based on a random number in accordance with the probabilities.

19. The system as recited in claim 12, further comprising training a classifier to build a predictive model using the actual trace.

20. The system as recited in claim 19, further comprising predicting outcomes of the one or more traces using the predictive model.
